(19) United States
(12) Patent Application Publication
(10) Pub. No.: US 2004/0249474 A1
(43) Pub. Date: Dec. 9, 2004

(54) Compare-plus-tally instructions

(76) Inventors: Ruby B. Lee, Princeton, NJ (US); Dale Morris, Steamboat Springs, CO (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/403,978

(22) Filed: Mar. 31, 2003

(51) Int. Cl. G05B 15/00

(52) U.S. Cl. 700/1

(57) ABSTRACT

Compare-plus-tally instructions are used to enhance video-compression performance by providing for faster computations of block-match measures. The invention is most useful in the context of comparing blocks from reference and predicted frames, where the luminance data for the blocks has been reduced to 1-bit-per-pixel relative to local average luminance. A combined XOR and tally instruction can be used in a two-instruction loop with an accumulate instruction to provide a block-match measure. Alternatively, a single instruction can implement an accumulation along with the comparison and tally to provide a one-instruction loop. Furthermore, the tallying and accumulation can be performed on a subword basis, with a final TreeAdd instruction summing across subwords outside the loop.

### BACKGROUND OF THE INVENTION

The present invention relates to computers and, more particularly, to computer programs and processors for executing them. The invention provides new instructions designed to enhance performance for such applications as video compression.

Video (especially with, but also without, audio) can be an engaging and effective form of communication. Video is typically stored as a series of still images referred to as “frames”. Motion and other forms of change can be represented as small changes from frame to frame as the frames are presented in rapid succession. Video can be analog or digital, with the trend being toward digital due to the increase in digital processing capability and the resistance of digital information to degradation as it is communicated.

Digital video can require huge amounts of data for storage and bandwidth for communication. For example, a digital image is typically described as an array of color dots, i.e., picture elements (“pixels”), each with an associated “color” or intensity represented numerically. The number of pixels in an image can vary from hundreds to millions and beyond, with each pixel being able to assume any one of a range of values. The number of values available for characterizing a pixel can range from two to trillions; in the binary code used by computers and computer networks, the typical range is from one bit to thirty-two bits.

In view of the typically small changes from frame to frame, there is a lot of redundancy in video data. Accordingly, many video compression schemes seek to compress video data in part by exploiting inter-frame redundancy to reduce storage and bandwidth requirements. For example, two successive frames typically have some corresponding pixel (“picture-element”) positions at which there is change and some pixel positions in which there is no change. Instead of describing the entire second frame pixel by pixel, only the changed pixels need be described in detail—the pixels that are unchanged can simply be indicated as “unchanged”. More generally, there may be slight changes in background pixels from frame to frame; these changes can be efficiently encoded as changes from the first frame as opposed to absolute values. Typically, this “inter-frame compression” results in a considerable reduction in the amount of data required to represent video images.

On the other hand, identifying unchanged pixel positions does not provide optimal compression in many situations. For example, consider the case where a video camera is panned one pixel to the left while videoing a static scene so that the scene appears (to the person viewing the video) to move one pixel to the right. Even though two successive frames will look very similar, the correspondence on a position-by-position basis may not be high. A similar problem arises as a large object moves against a static background: the redundancy associated with the background can be reduced on a position-by-position basis, but the redundancy of the object as it moves is not exploited.

Some prevalent compression schemes, e.g., MPEG, encode “motion vectors” to address inter-frame motion. A motion vector can be used to map one block of pixel positions in a first “reference” frame to a second block of pixel positions (displaced from the first set) in a second “predicted” frame. Thus, a block of pixels in the predicted frame can be described in terms of its differences from a block in the reference frame identified by the motion vector. For example, the motion vector can be used to indicate the pixels in a given block of the predicted frame are being compared to pixels in a block one pixel up and two to the left in the reference frame. The effectiveness of compression schemes that use motion estimation is well established; in fact, the popular DVD (“digital versatile disk”) compression scheme (a form of MPEG2) uses motion detection to put hours of high-quality video on a 5-inch disk.

Identifying motion vectors can be a challenge. Translating a human visual ability for identifying motion into an algorithm that can be used on a computer is problematic, especially when the identification must be performed in real time (or at least at high speeds). Computers typically identify motion vectors by comparing blocks of pixels across frames. For example, each 16×16-pixel block in a “predicted” frame can be compared with many such blocks in another “reference” frame to find a best match. Blocks can be matched by calculating the sum of the absolute values of the differences of the pixel values at corresponding pixel positions within the respective blocks. The pair of blocks with the lowest sum represents the best match, the difference in positions of the best-matched blocks determine the motion vector. Note that in some contexts, the 16×16-pixel blocks typically used for motion detection are referred to as “macroblocks” to distinguish them from 8×8-pixel blocks used by DCT (discrete cosine transformations) transformations for intra-frame compression.

For example, consider two color video frames in which luminance (brightness) and chrominance (hue) are separately encoded. In such cases, motion estimation is typically performed using only the luminance data. Typically, 8-bits are used to distinguish 256 levels of luminance. In such a case, a 64-bit register can store luminance data for eight of the 256 pixels of a 16×16 block; thirty-two 64-bit registers are required to represent a full 16×16-pixel block, and a pair of such blocks fills sixty-four 64-bit registers. Pairs of 64-bit values can be compared using parallel subword operations; for example, PSAD “parallel sum of the absolute differences” yields a single 16-bit value for each pair of 64-bit operands. There are thirty-two such results, which can be added or accumulated, e.g., using ADD or accumulate instructions. In all, about sixty-four instructions, other than load instructions, are required to evaluate each pair of blocks.

Note that the two-instruction loop (PSAD+ADD) can be replaced by a one-instruction loop using a parallel sum of the absolute differences and accumulate PSADAC instruction. However, this instruction requires three operands (the minuend register, the subtrahend register, and the accumulate register holding the previously accumulated value). Three operand registers are not normally available in general-purpose processors. However, such instructions can be advantageous for application-specific designs.

The Intel Itanium processor provides for improved performance in motion estimation using one- and two-operand instructions. In this case, a three-instruction loop is used. The first instruction is a PAveSub, which yields half the difference between respective one-byte subwords of two 64-bit registers. The half is obtained by shifting right one bit position. Without the shift, nine bits would be required to express all possible differences between 8-bit values. So the shift allows results to fit within the same one-byte subword positions as the one-byte subword operands.

These half-differences are accumulated into two-byte subwords. Since eight half-differences are accumulated into four two-byte subwords, the bytes at even-numbered byte positions are accumulated separately from bytes at odd-numbered byte positions. Thus, a “parallel accumulate magnitude left” PAccMagL accumulates half-differences at byte positions 1, 3, 5, and 7, while a “parallel accumulate magnitude right” PAccMagR accumulates the half-differences at byte positions 0, 2, 4, and 6. This loop can execute more quickly than the two-instruction loop described above, as a final sum is not calculated within each loop iteration. Instead, the four 2-byte subwords are summed once after the loop iterations end.

The four two-byte subwords can be summed outside the loop using an instruction sequence as follows. First, the final result is shifted to the right thirty-two bits. Then the original and shifted versions of the final result are summed. Then the sum is shifted sixteen bits to the right. The original and shifted versions of the sum are added. If necessary, all but the least-significant sixteen bits can be masked out to yield the desired match measure.

While the foregoing programs for calculating match measures are quite efficient, further improvements in performance are highly desirable. The number of matches to be evaluated varies by orders of magnitude, depending on several factors, but there can easily be millions to evaluate for a pair of frames. In any event, the block matching function severely taxes encoding throughput. Further reductions in the processing burden imposed by motion estimation are desired.

### SUMMARY OF THE INVENTION

The present invention provides for a computer instruction that performs a comparison and a tally on the results of the comparison. In addition, the invention provides for programs including such an instruction and data processors suited for executing such an instruction. For example, the instruction can XOR two operands and tally the number of is in the XOR result.

The comparison can be a bit-wise comparison in that a result is simply a function of one bit from each operand. XOR and XNOR are bit-wise comparison functions. Subtraction and the absolute value of differences are generally non-bit-wise functions as they involve carrying. However, there are bit-wise versions of each of these operations. Alternatively, a multi-bit comparison can be applied to operand subwords, e.g., with each subword corresponding to a pixel position.

The tally (also known as “Population Count”) can count either 0s or 1s. There can be one tally or several; for example, the comparison result can be divided into subwords and a separate tally performed on each subword. The instruction result can be the tally result or a non-identity function of the tally result. For example, the instruction result can be the sum of a tally result and an accumulation of previous tallies.

The invention further provides for programs with iterated loops including a combined comparison-plus-tally instruction. Typically, tally results are accumulated, either using the combined instruction or a separate accumulate or addition instruction.

One advantage of a combined compare-plus-tally instruction is that the comparison result is not limited to the processor register size. Thus, for example, the comparison result can provide a multi-bit value for each pixel position, where the number of 1s in the multi-bit value corresponds to the absolute value of the difference of the corresponding operand subwords. The tally result is then equal to the sum of the absolute value of the difference of the operand subwords—which is an accurate match measure.

The present invention enables high-performance motion estimation for video compression relative to prior-art methods in which the sum of the absolute value of the differences of pixel luminance values is calculated conventionally as a block-match measure. Tallying is faster than addition, providing some throughput advantage. Further speed gains are achieved when a bit-wise comparison is employed instead of multi-bit subtraction. An instruction combining a bit-wise comparison with a tally operation can executed faster than many common instructions so that the inventive combination does not require a longer instruction cycle. The invention further allows luminance data to be compressed prior to comparison and tallying. This allows more pixels to be processed in parallel, providing a further performance improvement.

The invention also provides advantages over non-prior programs in which a bit-wise comparison and a tally are performed with separate instructions. An example of such an alternative can involve separate comparison, tally, and accumulate instructions. Another alternative uses a comparison with a combined tally and accumulate instruction. Relative to the former, the invention requires fewer instructions per loop. Relative to the latter, the invention provides a better balance between instructions—and, therefore, potentially higher performance. In addition to its use in video compression and other image matching applications, the invention has applicability to encryption breaking. These and other features and advantages are apparent form the description below with reference to the following drawings.

### BRIEF DESCRIPTIION OF THE DRAWINGS

FIG. 1 is a flow chart indicating how a block-match measure is obtained using program instructions in accordance with the present invention.

FIG. 2 is a schematic diagram of a computer system with a microprocessor in accordance with the present invention.

FIG. 3 is a flow chart indicating how a block-match measure is obtained using program instructions in accordance with the present invention.

FIG. 4 is a flow chart indicating the operations involved in a parallel multi-bit compare-plus-tally instruction in accordance with the present invention.

### DETAILED DESCRIPTION

Some of the uses of the instructions provided for by the present invention involve image matching. The invention is particularly suited for 1-bit per pixel images, but also applies to images with two or more bits assigned per pixel. In video compression, 8-bit luminance data can be reduced, for example, to 1-bit- or 2-bits-per pixel luminance data relative to local average luminance, before generating block-match measures. Immediately below, the image data to be matched is 1-bit-per-pixel. Extensions to other pixel depths are discussed further below.

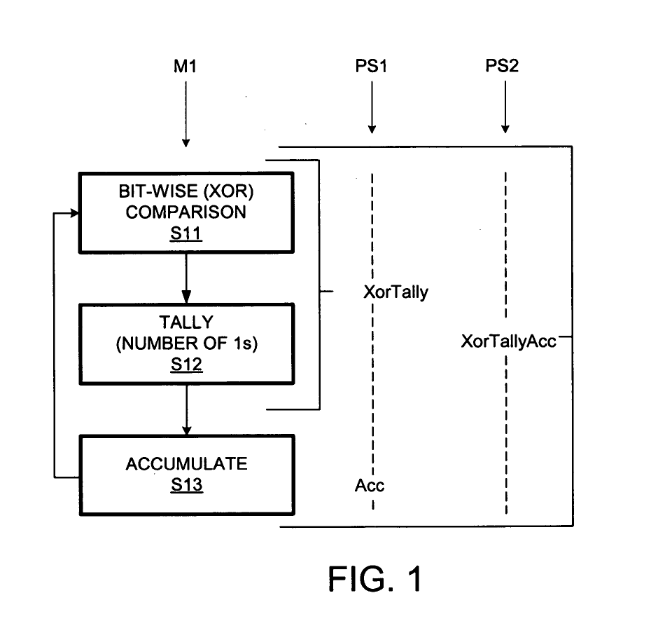

A method M1 employing compare-plus-tally instructions is flow-charted in FIG. 1. Method M1 is a three-operation loop occurring in the context of a video compression program 100. It is preceded in the program by a luminance bit-depth reduction from 8-bits absolute luminance data to 1-bit luminance data relative to local averages. The loop is iterated when the amount of data to be compared exceeds the word size for the microprocessor executing the program. For example, a 16×16-pixel block has 256 pixels. With one-bit-per-pixel relative luminance data, 256 bit-wise comparisons are required. Assuming 64-bit words, four pairs of 64-bit words are required to provide a block-match measure. The loop can be iterated four times, with the final accumulation result serving as the desired block-match measure.

Method M1 involves three operations: a bit-wise comparison S11, a tally S12, and an accumulation S13. In a non-prior-art alternative, each of these operations is associated with a different instruction. For example, the comparison can be performed using an XOR instruction, the tally can be performed using a tally (population-count) instruction, and the accumulation can be performed using an accumulate or add instruction. The present invention provides that the comparison and tally are performed using a single instruction, so that the loop contains only one or two instructions.

The invention provides for a program segment PS1 consisting of a two-instruction loop with a compare-plus-tally instruction XorTally r1, r2, r3. The comparison is an XOR operation, while the tally operation is a count of the 1s in the XOR result. The XorTally instruction has two operands: one, stored in a register specified by r1, represents luminance data associated with a reference block; the other, stored in a register specified by r2, represents luminance data from a predicted block. The result is a single 64-bit value to be stored in a register specified by r3. Of course, the maximum tally is 64 (for 64-bit operands) so only seven of sixty-four bits are required to represent the tally result.

In this two-instruction-loop program segment PS1, the accumulate instruction sums each tally with a previously accumulated value. This value is typically initialized to zero. Thus, in a first iteration of the loop, the result of the first accumulation is the same as the first tally result. In a second iteration of the loop, the second tally is added to the first. In a third iteration of the loop, the third tally is added to the previously accumulate sum of tallies. In a fourth and final iteration, the fourth tally is added to the previously accumulated sum of tallies; this final sum serves as a block-match measure to be compared with other block-match measures.

In a non-prior-art alternative, a separate operation is required for each operation S11, S12, and S13. Thus, the invention provides for reducing the number of instructions per loop, thus offering a potential performance improvement. However, this performance improvement would be offset if the use of the combined instruction required that the instruction cycle be lengthened. However, the latency associated with a combined XOR-plus-tally instruction is no more than that for an accumulate instruction. Thus, the number of instruction per loop is decreased without increasing the time required to execute each instruction; thus, the performance improvement associated with the reduced instruction count is realized.

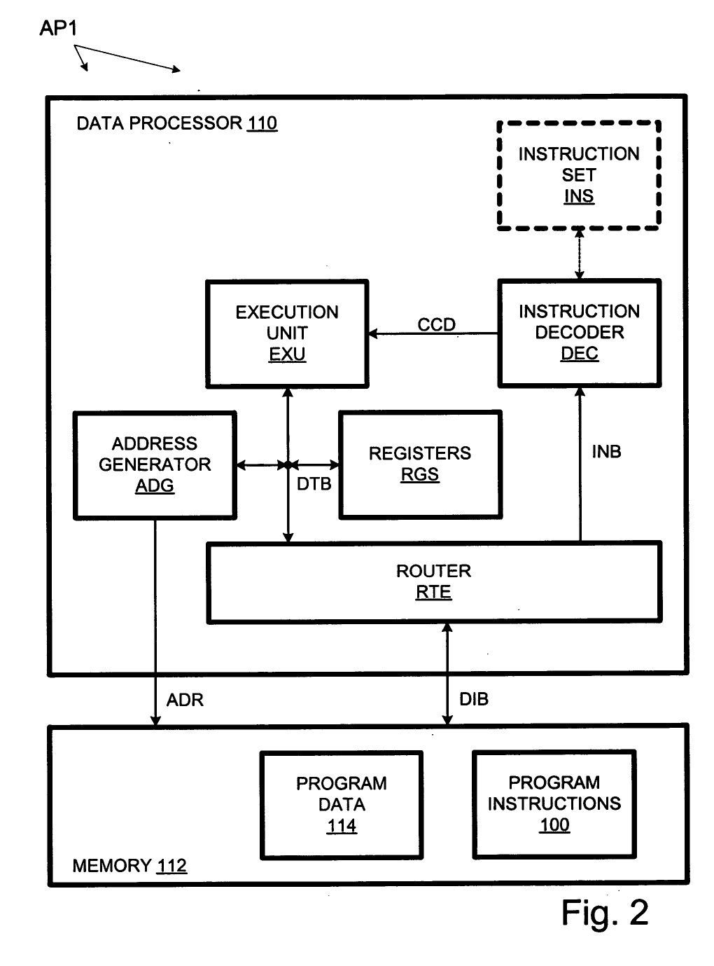

Program segment PS1 is part of a program 100. Program 100 is executed by computer system AP1, shown in FIG. 2, which comprises a data processor 110 and memory 112. The contents of memory 112 include program data 114 and instructions constituting a program 100. Microprocessor 110 includes an execution unit EXU, an instruction decoder DEC, registers RGS, an address generator ADG, and a router RTE. Unless otherwise indicated, all registers referred to in this detailed description are included in registers RGS.

Generally, execution unit EXU performs operations on data 114 in accordance with program 100. To this end, execution unit EXU can command (using control lines ancillary to internal data bus DTB) address generator ADG to generate the address of the next instruction or data required along address bus ADR. Memory 112 responds by supplying the contents stored at the requested address along data and instruction bus DIB.

As determined by indicators received from execution unit EXU along indicator lines ancillary to internal data bus DTB, router RTE routes instructions to instruction decoder DEC via instruction bus INB and data along internal data bus DTB. The decoded instructions are provided to execution unit EXU via control lines CCD. Data is typically transferred in and out of registers RGS according to the instructions.

Associated with microprocessor 110 is a set of instructions INS that can be decoded by instruction decoder DEC and executed by execution unit EXU. Program 100 is an ordered set of instructions selected from instruction set INS. For expository purposes, microprocessor 110, its instruction set INS, and program 100 provide examples of all the instructions described in this detailed description.

The invention further provides for implementing method M1 using a program segment PS2 with a single-instruction loop. In this case, an XorTallyAcc instruction is used. The syntax for the instruction is XorTallyAcc r1,r2,r3,r4, where r1 and r2 are registers containing pixel data to be compared, r3 contains a previously accumulated tally count, and r4 is the result register. While this implementation minimizes the number of instructions per loop iteration, it is more complex than either an accumulate instruction or a combined comparison/tally instruction. Where there are single-cycle instructions in the instruction set of comparable complexity, a performance improvement could still result. However, where an instruction requires a lengthening of the instruction cycle, the potential benefit of including this instruction in an instruction set is reduced.

Furthermore, the XorTallyAcc instruction requires that three operand registers be read. Most general-purpose processors do not provide for three-operand reads. Accordingly, this instruction is implemented in a dedicated multimedia processor. In an alternative embodiment, the instruction is implemented in a general-purpose processor with a special-purpose accumulation register used to store an accumulated result instead of an arbitrarily-specified general-purpose register. Note that if an instruction were designed to accumulate the tally into a special-purpose accumulation register, then typically the accumulation register would only be specified once in the assembly syntax: XorTallyAcc r1, r2, acc.

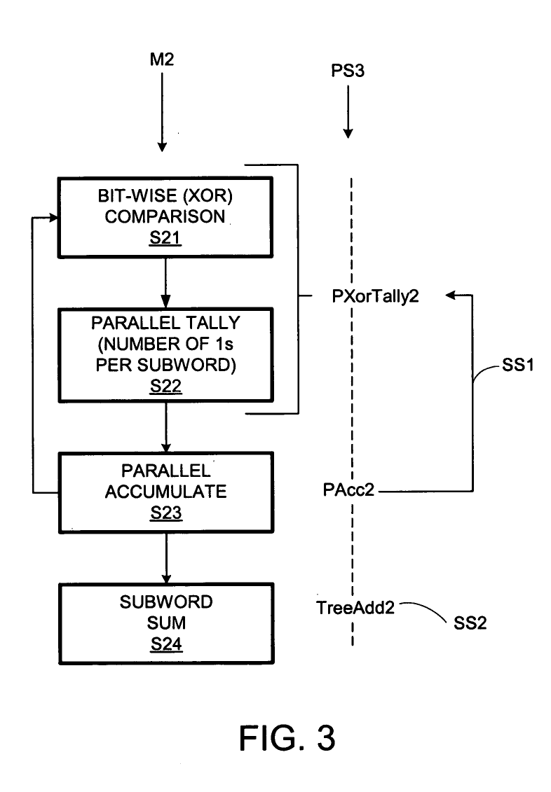

As flow-charted in FIG. 3, a third program segment PS3 of program 100 contains a two-instruction-loop subsegment SS1 plus one one-instruction terminating subsegment SS2. As with two-instruction-loop program segment PS1 of FIG. 1, loop subsegment SS1 includes an XOR-plus-tally instruction and an accumulate instruction. However, in subsegment SS1, the tally and accumulation operations are parallel subword instructions.

In this case, the compare instruction is PXorTally2 r1,r2,r3. The “2” signifies that the tally operation is performed on 2-byte subwords. (There is no difference between performing a bit-wise comparison such as XOR on a whole word or on the subwords.) This instruction provides four 16-bit results in a 64-bit result register. Each 16-bit result is the number of is in the respective 16 bits of an intermediate XOR result. PAcc2, the second instruction in loop subsegment SS1, adds each 16 bit tally result to a corresponding 16-bit accumulated value to yield a set of four 16-bit accumulated values in result register r3.

Loop subsegment SS1 can be iterated to permit all the pixels of a pair of blocks to be considered in determining a block-match measure. The result at the end of the last loop iteration is four 16-bit values. These need to be added to yield a single value as a block-match measure. While this addition can be performed using a series of shifts and additions, the preferred method is to use a single TreeAdd2 r1, r2 instruction of subsegment SS2. The term “TreeAdd” refers to the data path structure most appropriate for a microprocessor that implements the structure. The “2” again indicates two-byte subwords. Thus, the TreeAdd2 instruction stores the sum of four subwords in a first register r1 in a result register r2.

Note that no more than two operands are read by any instruction, so this variation is compatible with the general framework of a general-purpose processor. While it adds an extra TreeAdd instruction after the loop terminates, program segment PS3 uses shorter data paths within the loop so that the loop instructions can be executed faster than for program segment PS1 of FIG. 1. Depending on the extent of this savings and the number of loop iterations, program segment PS3 can realize a performance improvement relative to program segment PS1.

In the foregoing embodiments, luminance values are reduced to 1-bit-per-pixel. The invention can also apply to luminance values that are not reduced or are reduced to other depths, such as 2-bits per pixel. Where more than one bits-per-pixel are involved, a bit-wise comparison or a non-bit-wise comparison can be used. In an example for the former case, the operands can be XORed, ignoring bit significance. In an example of the latter case, the comparison can involve parallel subtraction of the luminance values. In either case, the tally ignores significance.

While ignoring significance can negatively impact the accuracy of the match measure obtained, the direct impact is on compression effectiveness and not directly on image quality. Furthermore, the performance gains provided by the invention can be traded off for wider searches for a best-matching reference block. In some cases, the wider search will result in a more accurate match measure than obtained using a prior-art method (without pixel depth reduction) and a narrower search for a best-matching reference block.

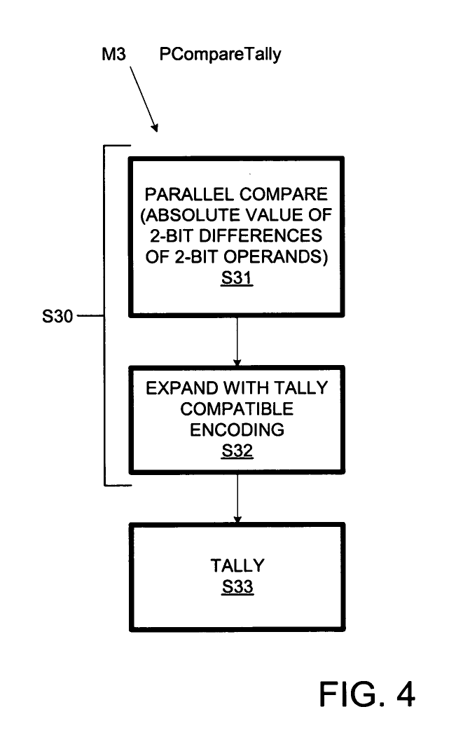

On the other hand, the invention provides for comparisons with multi-bit tally-compatible results that suffer no penalty in accuracy. A method M3, flow-charted in FIG. 4, includes operations performed by a generalized single parallel compare/tally instruction PCompareTally. For example, consider a pixel-reduction to 2-bits per pixel. Two 64-bit registers can store data for thirty-pixels from a reference block and a predicted block. The comparison is implemented at step S30 and includes substeps S31 and S32.

Substep S31 yields a 2-bit absolute value of difference for each of the thirty-two pixel pairs. Substep S32 expands the 2-bit result of substep S31 to a three-bit value. The encoding table is:

TABLE I
Comparison Encoding Scheme

| \|a-b\| | Encoded Value |
|---|---|
| 00 | 000 |
| 01 | 001 |
| 10 | 011 |
| 11 | 111 |

Note that the number of Is in the encoded value equals the corresponding value for the absolute value of the difference. Therefore, when the tally is performed at step S33, the result is equal to the sum of the absolute value of the differences.

More generally, the result of the tally operation can be as accurate as required by selecting a comparison operation that yields results suitable for tallying. Since it is not required to be present in a program-accessible register, the comparison result is not limited by the processor word size. Thus, the number of bits allocated per pixel position for the comparison result can be much larger than the register size.

For another example of method M3, consider a bit-depth reduction to 3-bits-per-pixel according to the following encoding scheme:

TABLE II
Reduction to 3-bits

| value | range | | comment |
|---|---|---|---|
| 000 | a > | pixel ≧ 0 | minimum range |
| 001 | b > | pixel ≧ a | very low range |
| 010 | c > | pixel ≧ b | low range |
| 011 | d > | pixel ≧ c | average range |
| 100 | e > | pixel ≧ d | high range |
| 101 | f > | pixel ≧ e | very high range |
| 110 | 255 ≧ | pixel ≧ f | maximum range |

where a, b, c, d, e, and f are 8-bit values in a monotonic progression, where d and c bracket a local average value.

The comparison operation S30 yields a 5-bit result in which the number of is in the result indicates the magnitude of the separation of ranges for the operands. Thus, 00000 indicates the 3-bit operand ranges are equal, 00001 indicates they are one range apart, 00011 indicates they are two ranges apart, 00111 indicates they are three ranges apart, 01111 indicates they are four ranges apart, and 11111 indicates they are five or more ranges apart. The tally results in an accurate albeit reduced-precision measure of match for the pixel positions involved. In another instruction in accordance with the invention, the instruction result is an accumulation of the present tally with a previously calculated value.

The invention can also handle reductions to non-integer bit depths. For example, three values can be used to distinguish pixels that have luminance 1) equal to, 2) above, or 3) below a local average luminance. In this case, the effective bit depth is log₂ 3, which is not an integer. Preferably, in this case, two bits are used to express the three possible operand values for each pixel luminance value. An XOR comparison, ignoring significance, can provide a 2-bit result for each pixel. Also, neighboring pixels can be assigned common values, in which case fractional bit depths can be involved.

The present invention has application to video compression and to other image matching applications. In addition, the present invention can be used in encryption-breaking applications where the invention can provide a fast measure of decryption accuracy. The invention provides for different word sizes, as well as different bit-wise comparison operations and different tally operations. These and other variations upon and modifications to the detailed embodiments are provided for by the present invention, the scope of which is defined by the following claims.

What is claimed is:

1. A program comprising a comparison instruction that, when executed, performs a comparison between two operands to define a comparison result and tallies a number of 1s or 0s in said comparison result to define a tally result, said instruction yielding an instruction result that is at least in part a function of said tally result.

2. A program as recited in claim 1 wherein said comparison is a bit-wise operation.

3. A program as recited in claim 1 wherein said comparison is an XOR operation.

4. A program as recited in claim 3 wherein said tally result is the number of 1s in said comparison result.

5. A program as recited in claim 4 wherein said instruction result is said tally result.

6. A program as recited in claim 5 further comprising an addition instruction that adds said instruction result to a predetermined determined value

7. A program as recited in claim 6 further comprising a two-instruction loop in which said instructions are iterated

8. A program as recited in claim 4 wherein said comparison instruction sums said tally result with a previously determined value.

9. A program as recited in claim 8 further comprising a one-instruction loop in which said comparison instruction is iterated.

10. A program as recited in claim 1 wherein said tally result includes plural tally values corresponding to respective subwords of said comparison result.

11. A program as recited in claim 10 wherein said instruction result is said tally result, each of said tally values is the number of 1s in said respective subword, and said bit-wise comparison is an XOR operation.

12. A program as recited in claim 1 wherein said comparison operation yields a comparison result having more bits than either of said operands.

13. A program as recited in claim 12 wherein said tally operation equals the sum of the absolute value of the differences of luminance values represented by said operands.

14. A program as recited in claim 13 wherein said tally result is said instruction result.

15. A program as recited in claim 13 wherein said instruction result is a non-identity function of said tally result.

16. A program as recited in claim 13 wherein said instruction result is the sum of said tally result and a predetermined value.

17. A data processor comprising an instruction decoder for decoding and an execution unit for executing a combined compare and tally instruction, said instruction, when executed defining a comparison result from a comparison of two operands and a tally result from a count of a number of 1s or 0s in said comparison result, said instruction providing an instruction result that is, at least in part, a function of said tally result.

18. A data processor as recited in claim 17 wherein said comparison is a bit-wise comparison.

19. A data processor as recited in claim 18 wherein said bit-wise comparison is an XOR operation.

20. A data processor as recited in claim 19 wherein said tally result is the number of 1s in said comparison result.

21. A data processor as recited in claim 20 wherein said instruction result is said tally result.

22. A data processor as recited in claim 20 wherein said instruction result is a non-identity function of said tally result and a previously determined result.

23. A data processor as recited in claim 18 wherein said tally is a parallel subword operation.

24. A data processor as recited in claim 17 wherein said comparison is not a bit-wise operation.

25. A data processor as recited in claim 24 wherein said comparison result is a function of the absolute value of the differences of subwords of said operands.

26. A data processor as recited in claim 25 wherein said tally result equals the sum of absolute values of the differences of subwords of said operands.

27. A data processor as recited in claim 26 wherein said instruction result is the sum of said tally result and a predetermined value.

28. A data processor as recited in claim 17 wherein the number of bits in said comparison result exceeds the number of bits in either of said operands.
